(19) United States
(12) Patent Application Publication
(10) Pub. No.: US 2018/0165419 A1
(43) Pub. Date: Jun. 14, 2018

(54) BIOMETRIC DISEASE GROWTH PREDICTION

(71) Applicant: International Business Machines Corporation, Armonk, NY (US)

(72) Inventors: RAJARAM B. KRISHNAMURTHY, Pleasant Valley, NY (US); CHRISTINE D. MIKIJANIC, Monroe, NY (US)

(21) Appl. No.: 15/372,815

(22) Filed: Dec. 8, 2016

(51) Int. Cl. G06F 19/00

(52) U.S. Cl. CPC G06F 19/3437

(57) ABSTRACT

Embodiments include methods, systems and computer program products for patterning and predicting the growth of infectious diseases through analysis of portable objects. Aspects include receiving biometric data from a plurality of nodes. Aspects also include optionally receiving personalized node data. Aspects also include storing biometric data. Aspects also include determining a growth pattern from the biometric data. Aspects also include calculating a projected growth pattern for the pathogen. Aspects also include outputting the projected growth pattern to a user interface.

### BACKGROUND

The present invention relates generally to analyzing portable objects to pattern and predict infectious diseases, and more specifically to methods, systems, and computer program products for patterning and predicting the growth of infectious diseases through analysis of portable objects.

The spread of infectious diseases in centralized social zones is a pervasive problem. For example, in the course of one semester, a college professor might grade over on hundred papers. Some of those papers can carry more than the student's knowledge and can also include a variety of infectious materials, including bacteria and viruses. Frequently, teachers and professors receive papers or other portable objects that have been sneezed on, handled by ill students, or that have landed in contaminated areas such as the floor of a bathroom. In the exemplary context of a college campus, teachers are not the only population subject to the spread of disease through the passage of portable objects. For instance, anyone that pulls paper from a printer could come into contact with infectious materials. Thus, centralized social zones can become breeding grounds for bacteria and viruses. Moreover, not only are schools notorious incubating facilities for new strains of infectious disease, but any facility where a large number of people are in close quarters for extended periods of time can also serve as incubators and hubs for the growth and spread of pathogens.

### SUMMARY

In accordance with one or more embodiments, a computer-implemented method for patterning growth of infectious diseases is provided. The method includes receiving biometric data from a plurality of nodes, wherein the biometric data includes a characterization of a pathogen derived from a plurality of portable objects. The method also includes storing the biometric data to a database. The method also includes determining a growth pattern for the pathogen based at least in part upon the characterization of the pathogen. The method also includes calculating a projected growth pattern for the pathogen based at least in part upon the growth pattern. The method also includes outputting the projected growth pattern to a user interface.

In accordance with another embodiment, a computer program product for patterning growth of infectious diseases includes a storage medium readable by a processing circuit and storing instructions for execution by the processing circuit for performing a method. The method includes receiving biometric data from a plurality of nodes, wherein the biometric data includes a characterization of a pathogen derived from a plurality of portable objects. The method also includes storing the biometric data to a database. The method also includes determining a growth pattern for the pathogen based at least in part upon the characterization of the pathogen. The method also includes calculating a projected growth pattern for the pathogen based at least in part upon the growth pattern. The method also includes outputting the projected growth pattern to a user interface.

In accordance with a further embodiment, a processing system for patterning growth of infectious diseases includes a processor in communication with one or more types of memory. The processor is configured to receive biometric data from a plurality of nodes, wherein the biometric data includes a characterization of a pathogen derived from a plurality of portable objects. The processor is also configured to store the biometric data to a database. The processor is also configured to determine a growth pattern for the pathogen based at least in part upon the characterization of the pathogen. The processor is also configured to calculate a projected growth pattern for the pathogen based at least in part upon the growth pattern. The processor is also configured to output the projected growth pattern to a user interface.

### BRIEF DESCRIPTION OF THE DRAWINGS

The subject matter of the invention is particularly pointed out and distinctly claimed in the claims at the conclusion of the specification. The foregoing and other features and advantages of the one or more embodiments described herein are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a computer system according to one or more embodiments of the present invention;

FIG. 4 is a diagram illustrating a system for patterning and predicting growth of infectious diseases according to one or more embodiments of the present invention;

FIG. 5 is a flow diagram illustrating a method for patterning and predicting growth of infectious diseases according to one or more embodiments of the present invention.

### DETAILED DESCRIPTION

It is understood in advance that although this description includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure including a network of interconnected nodes.

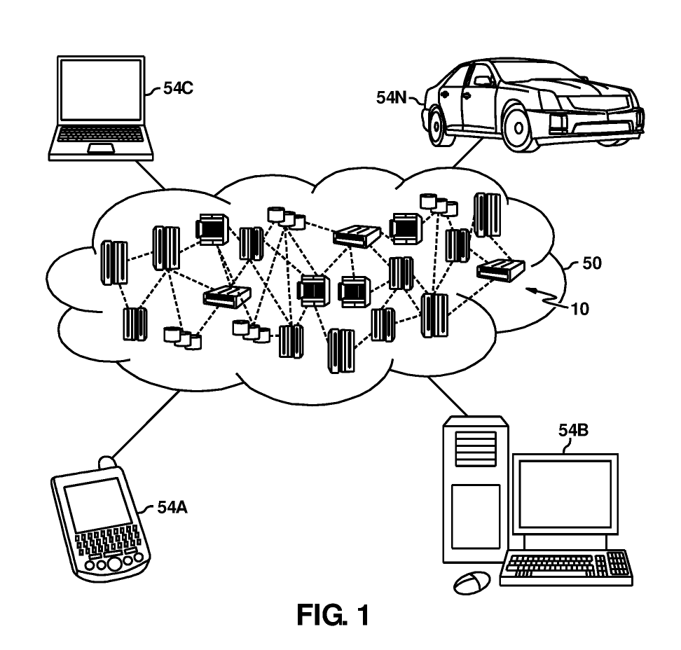

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

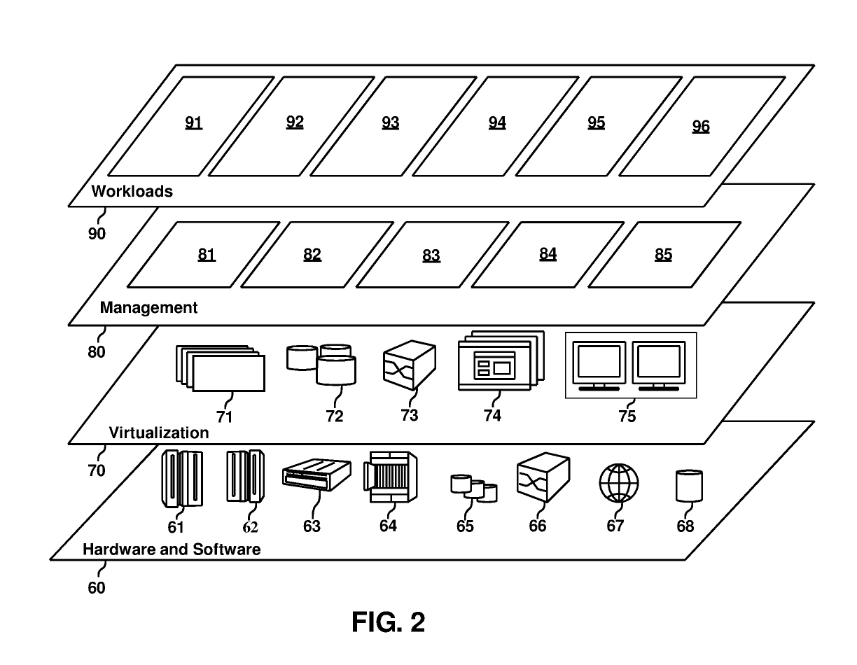

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and infectious disease growth patterning and prediction 96.

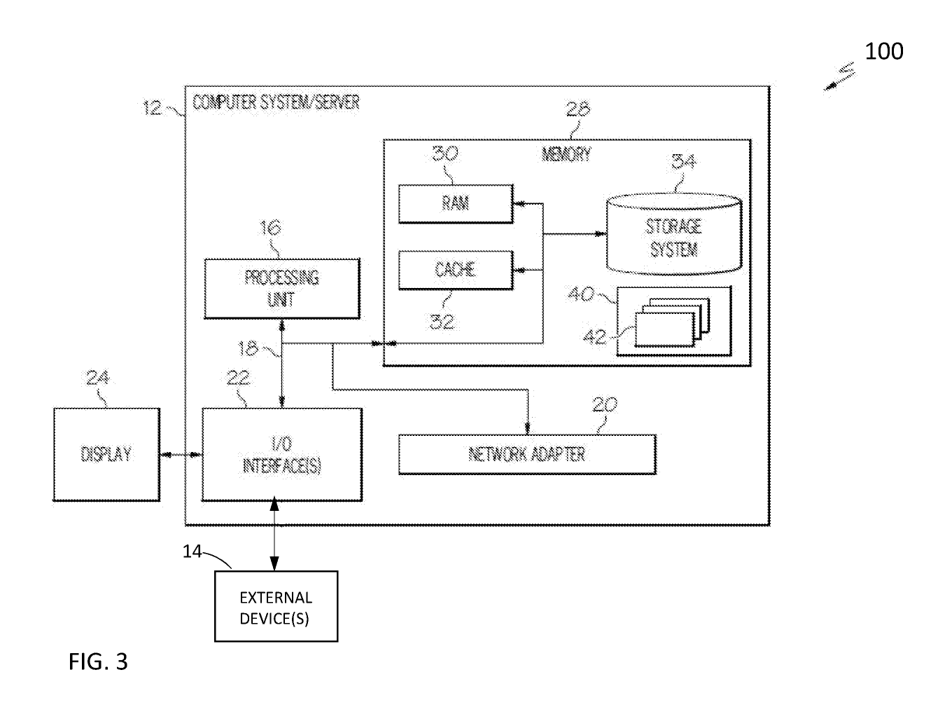

Referring now to FIG. 3, a schematic of a cloud computing node 100 included in a distributed cloud environment or cloud service network is shown according to a non-limiting embodiment. The cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 12, which is operational with numerous other general purpose or special purpose computing system environments or configurations. Examples of well-known computing systems, environments, and/or configurations that can be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 can be described in the general context of computer system-executable instructions, such as program modules, being executed by a computer system. Generally, program modules can include routines, programs, objects, components, logic, data structures, and so on that perform particular tasks or implement particular abstract data types. Computer system/server 12 can be practiced in distributed cloud computing environments where tasks are performed by remote processing devices that are linked through a communications network. In a distributed cloud computing environment, program modules can be located in both local and remote computer system storage media including memory storage devices.

Tracking the growth and spread of infectious diseases in the context of both large and small populations is of great interest. For example, in cases of a biological attack, tracking and predicting the growth or patterning of infectious diseases or biological agents can be paramount to ensure the safety of large populations. On a smaller scale, such information is also desired and sought out. For example, parents of school-aged children can seek to know when a flu virus has been detected in their child's school so they can take extra precautions to ensure adequate handwashing in an effort to reduce the likelihood of developing those conditions within their own families. Pathogens are not only transmitted through human-human contact but can also be transmitted through contact with portable objects. For instance, in a school system, pathogens can be transmitted through the passage of contaminated papers, pencils, pens, and books. Not only can the identification of specific pathogens being transmitted be valuable to promoting the health of the population, but predicting the spread of pathogens based upon analysis of pathogen and other data collected over time and in various locations can assist with control of the spread of the pathogen.

Embodiments of the invention can allow identification and tracking of pathogens through sampling of portable objects. In some embodiments, pathogen information from a plurality of portable objects can be collected and subjected to analysis at a terminal device. Through communication between terminal devices, a learning machine, and a network-based back end, over time and with an increased input of portable object pathogen data, transmission of infectious diseases can be tracked. Moreover, in some embodiments, in addition to tracking transmission of infectious diseases, the spread of infectious diseases can be predicted and characterized.

As shown in FIG. 3, computer system/server 12 in cloud computing node 100 is shown in the form of a general-purpose computing device. The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24, etc., one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to microcode, device drivers, redundant processing units, external disk drive arrays, RAID systems, tape drives, and data archival storage systems, etc.

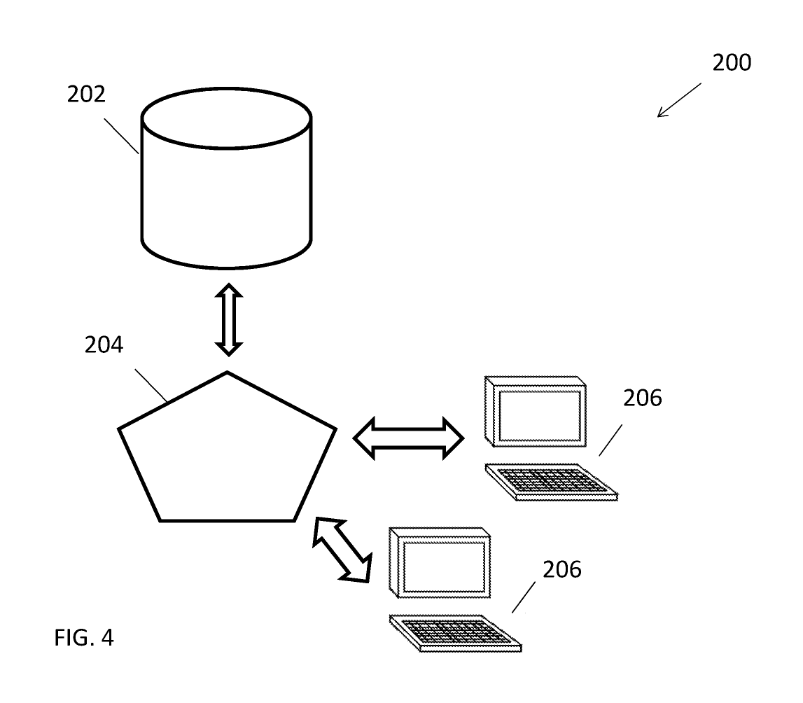

FIG. 4 is a diagram illustrating a system 200 for patterning and predicting growth of infectious diseases according to one or more embodiments of the present invention. The system includes a network-based back end 202. The system 200 also includes a learning machine 204. The system 200 also includes a plurality of terminal devices 206.

Network-based back end 202 includes data storage, including storage of personalized information and specialized personal information. The network-based back end can include, for example, cloud infrastructure. In some embodiments, the network-based back end can include a private cloud, a community cloud, a public cloud, or a hybrid cloud. In some embodiments, the network-based back end 202 communicates with an organization involved in or interested in the analysis of infectious diseases, such as a government organization, a university, or another research institute. For example, a network-based back end 202 can provide information, such as pathogen information and data, biological information and data, personalized information, and/or special personalized information to the U.S. Department of Health, the National Institutes of Health, the Centers for Disease Control, or the World Health Organization.

In some embodiments, network-based back end 202 communicates with learning machine 204. In some embodiments, learning machine 204 includes a processor and can sort and analyze data. The learning machine could be a chip such as the IBM TrueNorth chip or NVidia GPU or Xilinx FPGA or embedded processor that has been “trained” to perform pathogen growth and movement prediction functions as described elsewhere. The model may be trained in the cloud and then deployed in the learning machine. The learning machine may perform “online” learning as it infers or predicts pathogen growth and movement. As an example, online learning is used to update an existing trained model to improve its future prediction or inference capability. This can happen during pathogen growth prediction when a newly mutated pathogen may deviate from its expected behavior and real-time updates to an existing trained model leads to enhanced future prediction.

Terminal devices 206 can communicate with the learning machine 204 and can take a variety of forms and perform a variety of functions. In some embodiments, terminal devices 206 include a user interface, such as a computer or tablet display, a keyboard, and/or a touchpad. Terminal devices can include, for example, smartphones, tablets, computers, and laptop computers. Terminal devices can also include instrumentation related to pathogen detection, analysis, or removal. For example, in some embodiments, terminal devices include automated or interactive instrumentation related to technologies suitable for detection or analysis of viruses, bacteria, and other pathogens, including, for example, lab-on-a-chip devices, cell-culture based technologies, immunological assays, including for instance enzyme-linked immunoabsorbent assays (ELISA), molecular assays including, for instance, polymerization based sequencing (PCR) technologies and other nucleic acid sequencing assays, and spectroscopic devices and technologies, such as Raman-based devices or flow cytometry devices. Other instrumentation related to technologies suitable for detection of pathogens is known and can be used in accordance with some embodiments.

Access to the terminal devices 206, network-based back end 202, and learning machine 204 can be restricted in whole or part. For example, access to information stored in the network-based back end 202, which in some embodiments can contain special personal information, can be restricted to users or institutions having designated confidentiality restrictions or access to documents having a specified classification. At an academic institution, for example, access to a terminal device 206 can be restricted to academic instructors. As will be appreciated by a person of skill in the art, multiple levels of access can be tailored to a given system, for example in a manner that can optimize the transmission and analysis of data while maintaining a desired level of confidentiality for sensitive personal information. Access to system components can be restricted by any known methods, including through the use of encryption and decryption, access codes, access cards, access through fingerprints, retinal scans or the like, or any combination of such methods or similar methods.

In accordance with some embodiments, samples for pathogen testing and analysis can be taken from portable objects. Portable objects can include any objects that can be picked up by a user and moved to another location, such as papers or office supplies.

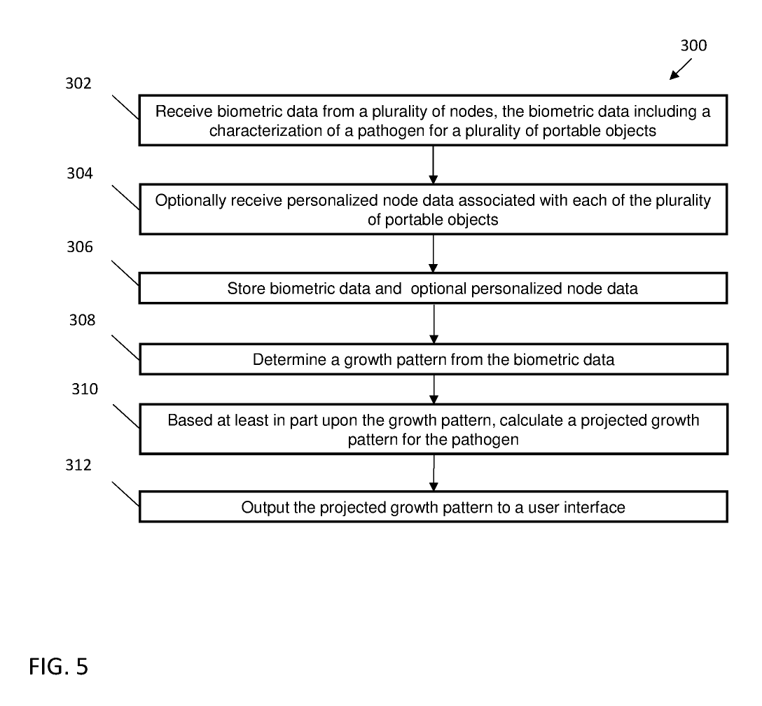

Referring now to FIG. 5, a flow chart illustrating a method 300 for patterning or predicting the growth of infectious diseases according to one or more embodiments of the invention is provided. The method 300 includes, as is shown at block 302, receiving biometric data from a plurality of nodes. The biometric data can include a characterization of a pathogen for a plurality of portable objects. The method 300 also includes optionally receiving personalized node data associated with each of the plurality of portable objects, as is shown at block 304. The method 300 also includes, as is shown at block 306, storing biometric data and optionally storing personalized node data. In some embodiments, biometric data and personalized node data can be stored to a local or network database. In some embodiments, a node is a user of a terminal device and/or a source of a portable object. The method 300 also includes, as is shown in block 308, determining a growth pattern from the biometric data. The method 300 also includes, as is shown at block 310, based at least in part upon the growth pattern, calculating a projected growth pattern for the pathogen. The method 300 also includes outputting the projected growth pattern to a user interface, as is shown at block 312.

Biometric data includes any information relevant to the characterization of the transmission of pathogens, including information relevant to the identity of the pathogen, such as a virus or bacteria type; the characterization of the pathogen, such as the species, variant or strain of the pathogen; the amount of the pathogen detected; the source of the pathogen; the source of the portable object; the source of data; personalized information concerning the user inputting the data or that handled or generated the portable object; such as the person's medical history, identity, or schedule of movements within the facility; locational or geographic information; and temporal data including, for instance, the date and time pathogen related data was collected.

In some embodiments, a growth pattern is determined from the biometric data. A growth pattern can be determined by known methods. For example, biometric data can be collected from a plurality of nodes or terminal devices. A learning machine can collect and analyze the data to determine a current growth pattern for the pathogen. The current growth pattern can include, for example, geographic transmission information or temporal transmission information, including the rate of spread or the direction of the spread of disease. A growth pattern can be stored to the network-based back end. In some embodiments, a growth pattern can be transmitted to an external recipient, such as the administration of the institution experiencing the infectious disease, to the U.S. Department of Health, or to the National Institute of Health.

In some embodiments, methods include predicting a growth pattern based at least in part upon the growth pattern for the pathogen. In some embodiments, a growth pattern is determined by using machine learning techniques. The machine learning techniques can include, for example, Support Vector Machine Regression, Bayesian additive regression trees, and the like. In an embodiment, data related to pathogen identification and characterization, including biometric data, is monitored over time. Certain methods can include receiving data related to infectious disease, generating forecast information using an error-weighted ensemble method, and providing the forecast of infectious disease transmission. In a supervised learning scenario, growth of pathogen concentration in sampling regions along with movement of pathogens between the sampling regions is stored in a data structure, for example, a network graph with vertices and directed edges. The local growth of pathogens at a vertex or “sampling region” and movement of pathogens along directed edges is used to update the network graph model. A list of pathogens and associated mutations and variants is stored along with the network graph. The network graph may be used to train a deep neural network so it learns the local growth of pathogen concentration and movement of pathogens. The “training” of the model with appropriate labels is performed from a large set of training samples. Once the model is trained, it may be used to predict the path and growth of pathogens when biometrics indicates the presence of pathogens.

In some embodiments, systems and methods include the sterilization of portable objects. For example, a terminal device 206 can include a sterilization component. In some embodiments, a sterilization component includes a device capable of destroying pathogens without damaging the portable object, including, for instance, radiation, such as UV radiation or heating. In some embodiments, portable objects are heated to a temperature sufficient to kill a plurality of vertebrates or bacterium. In some embodiments, a portable object is heated to a temperature between 100 and 400° C., such as between 130 and 200° C. For example, it is known that many vertebrate and bacteria cannot survive at temperatures around 130° C. or higher. As will be appreciated by a person of ordinary skill in the art, characteristics of the portable object can be taken into account when selecting a sterilization method. For example, paper is known to be relatively delicate. Contact of paper with viscous material can damage paper fibers. Furthermore, paper can be subject to ignition upon application of temperatures in the range of 440 to 470° F. In some embodiments, the system includes a sterilization compartment. In some embodiments, the sterilization compartment includes an insulated box. The insulated box can include, for example, a drawer that can hold several papers and electric heating coils on any number of the inside walls, for instance, heating coils of the type used in electric blankets. The sterilization compartment can also include a timer, for instance, a timer that opens the drawer upon completion of a sterilization cycle, and/or a lock to keep material safely within the sterilization compartment.

For example, in operation, a teacher using the system 200 at a university can analyze a plurality of student essays for pathogenic materials at a terminal device 206. The terminal devices 206 can obtain a variety of data, such as date, time, identity and personal details of the teacher, identity of any pathogens detected, and amounts of pathogens detected. The terminal devices 206 can sterilize the student essays through UV irradiation before returning to the teacher.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for patterning growth of infectious diseases comprising:
receiving, by a processor, biometric data associated with a plurality of portable objects from a plurality of nodes, wherein the biometric data comprises a characterization of a pathogen associated with one or more of the portable objects;
storing, by the processor, the biometric data to a database;
determining, by the processor, a growth pattern for the pathogen based at least in part upon the characterization of the pathogen by using a machine learning technique, wherein the growth pattern comprises a direction of a spread of disease;
calculating, by the processor, a projected growth pattern comprising a path—for the pathogen based at least in part upon the growth pattern using an error-weighted ensemble method; and
outputting the projected growth pattern to a user interface.

2. The computer-implemented method of claim 1, wherein the plurality of portable objects comprise paper.

3. The computer-implemented method of claim 1, wherein the biometric data comprises a pathogen identity.

4. The computer-implemented method of claim 1, further comprising identifying a portable object in need of sterilization and initiating sterilization of the plurality of portable objects at a terminal device.

5. The computer-implemented method of claim 1, comprising outputting the biometric data to an external recipient.

6. The computer-implemented method of claim 1, further comprising encrypting the biometric data.

7. The computer-implemented method of claim 1, further comprising receiving, by the processor, personalized node data.

8. A computer product for patterning growth of infectious diseases, the computer product comprising:
a storage medium readable by a processing circuit and storing instructions for execution by the processing circuit for performing a method comprising:
receiving biometric data associated with a plurality of portable objects from a plurality of nodes, wherein the biometric data comprises a characterization of a pathogen associated with one or more of the portable objects;
storing the biometric data to a database;
determining a growth pattern for the pathogen based at least in part upon the characterization of the pathogen by using a machine learning technique, wherein the growth pattern comprises a direction of a spread of disease;
calculating a projected growth pattern comprising a path for the pathogen based at least in part upon the growth pattern; and
outputting the projected growth pattern to a user interface.

9. (canceled)

10. The computer program product of claim 8, wherein the plurality of portable objects comprise paper.

11. The computer program product of claim 8, wherein the biometric data comprises a pathogen identity.

12. The computer program product of claim 8, wherein the method further comprises identifying a portable object in need of sterilization and initiating sterilization of the plurality of portable objects at a terminal device.

13. The computer program product of claim 8, wherein the method further comprises outputting the biometric data to an external recipient.

14. The computer program product of claim 8, wherein the method further comprises encrypting the biometric data.

15. The computer program product of claim 8, wherein the method further comprises receiving personalized node data.

16. A processing system for patterning growth of infectious diseases, comprising:
a processor in communication with one or more types of memory, the processor configured to:
receive biometric data associated with a plurality of portable objects from a plurality of nodes, wherein the biometric data comprises a characterization of a pathogen associated with one or more of the portable objects;
store the biometric data to a database;
determine a growth pattern for the pathogen based at least in part upon the characterization of the pathogen by using a machine learning technique, wherein the growth pattern comprises a direction of a spread of disease;
calculate a projected growth pattern comprising a path for the pathogen based at least in part upon the growth pattern; and
output the projected growth pattern to a user interface.

17. The processing system of claim 16, wherein the plurality of portable objects comprise paper.

18. The processing system of claim 16, wherein the biometric data comprises a pathogen identity.

19. The processing system of claim 16, wherein the processor is further configured to identify a portable object in need of sterilization and initiate sterilization of the plurality of portable objects at a terminal device.

20. The processing system of claim 16, wherein the processor is further configured to encrypt the biometric data.
